(19) United States
(12) Patent Application Publication
(10) Pub. No.: US 2025/0289331 A1
(43) Pub. Date: Sep. 18, 2025

(54) ELECTRIC VEHICLE CHARGING APPARATUS

(71) Applicants: HYUNDAI MOTOR COMPANY, Seoul (KR); KIA CORPORATION, Seoul (KR)

(72) Inventors: Yong Chul Shin, Hwaseong-si (KR); Dong Hun Lee, Hwaseong-si (KR); Byung Ho Yoon, Hwaseong-si (KR); Ki Hoon Nam, Hwaseong-si (KR)

(73) Assignees: HYUNDAI MOTOR COMPANY, Seoul (KR); KIA CORPORATION, Seoul (KR)

(21) Appl. No.: 18/930,524

(22) Filed: Oct. 29, 2024

(30) Foreign Application Priority Data
Mar. 12, 2024 (KR) 10-2024-0034568

(51) Int. Cl. B60L 53/16; B60L 53/30

(52) U.S. Cl. CPC B60L 53/16; B60L 53/30

(57) ABSTRACT

An electric vehicle charging apparatus includes an electric vehicle charging part including a docking area that connects to a charging port of an electric vehicle, and a charging port opening-closing part that is mounted on the electric vehicle charging part.

### CROSS-REFERENCE TO RELATED APPLICATION

This application claims the benefit of and priority to Korean Patent Application No. 10-2024-0034568, filed in the Korean Intellectual Property Office on Mar. 12, 2024, the entire contents of which are incorporated herein by reference.

### TECHNICAL FIELD

The present disclosure relates to an electric vehicle charging apparatus.

### BACKGROUND

Researches are being actively conducted on electric vehicles (or hybrid vehicles) as they are the most likely alternatives to solving automobile pollution and energy problems. Because these electric vehicles generate a driving force through an electric motor (e.g., a drive motor) that obtains a rotational force from electrical energy, they are equipped with a battery that may supply the electrical energy that is necessary for operating the electric motor and for an operation of an electric vehicle. The battery mounted on the vehicle has to be able to be recharged at any time.

For charging (battery charging) an electric vehicle, a (e.g., a charging port) and a charging port cover, which protects the charging port from exposure to environmental elements such as rain or snow, may be provided in the vehicle body. Conventionally, to charge a battery, the user has to manually connect a charger from a charging station to the charging port and then disconnect the charger from the charging port after the charging is completed, which is bothersome and inconvenient.

Meanwhile, a method of performing a process of connecting a charger to a charging port in an unmanned manner by using a charging robot has been proposed.

However, conventionally, even though the process of connecting the charger to the charging port is automated using a charging robot, the charging port cover has to be opened and closed manually by the user, and thus, it is difficult to automate and eliminate manual intervention in the charging process for electric vehicles.

The statements in this section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides an electric vehicle charging apparatus that may automate and eliminate manual intervention in the process of charging electric vehicles.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, an electric vehicle charging apparatus includes: an electric vehicle charging part including a docking area that connects to a charging port of an electric vehicle, and a charging port opening/closing part that is mounted on the electric vehicle charging part. The charging port opening/closing part may include a fixed part fixed to the electric vehicle charging part, and a movable part that is movably connected to the fixed part. The movable part may be movable with respect to the fixed part between a first position, in which an end of the movable part in a docking direction is located in the docking direction of the docking area, and a second position located in an opposite docking direction of the docking area. Here, the docking direction is defined as a direction in which the docking area approaches and connects to the charging port, and an opposite direction to the docking direction is defined as the opposite docking direction.

Furthermore, the docking direction may cross an upward-downward direction, and the movable part may be disposed on a lower side of the docking area.

Furthermore, the movable part may include: a connection area defining one end of the movable part, and connected to the fixed part, and a movement area defining an opposite end of the movable part, and that is movable with respect to the connection area, and the charging port opening-closing part may further include a fingertip connected to the movement area, and including a section having a shape protruding with respect to the movement area in a direction crossing the docking direction with reference to a time, at which the movable part is oriented in parallel to the docking direction.

Furthermore, when an imaginary straight line extending in the direction crossing the docking direction, and passing through a portion, at which the connection area and the fixed part are connected to each other, is defined as a reference rotation axis, the connection area is connected to the fixed part to be rotatable about the reference rotation axis, and the movement area may be revolved about the reference rotation axis.

Furthermore, the movable part may include a movable body extending between the connection area and the movement area, and connecting the connection area and the movement area, and the charging port opening-closing part may further include an elastic member. The elastic member includes; one end connected to the fixed part, and an opposite end connected to the movable body to be prolonged or contracted.

Furthermore, the elastic member may be provided as a tensile coil spring, and is oriented in the direction crossing the docking direction when the movable body is oriented in parallel to the docking direction.

Furthermore, the elastic member may be oriented such that the opposite end of the elastic member is located on a lower side of and in the docking direction of the one end of the elastic member when the movable body is oriented in parallel to the docking direction.

Furthermore, when a direction, in which the connection area faces the movement area is defined as a first direction, and a direction crossing the first direction, and in which the section of the fingertip protrudes, is defined as a second direction, the shape of the section of the fingertip may have a width in the first direction. The width becomes smaller as it goes in the second direction.

Furthermore, the charging port opening-closing part may further include a driving part that rotates the movable part with respect to the fixed part. In particular, the movable part may include: a first link having one end connected to the fixed part and configured to be rotatable; a second link having on end connected to an opposite end of the first link and configured to be rotatable; and a driving link having one end connected to the driving part, and an opposite end connected to the second link and configured to be rotatable. The charging port opening-closing part may further include a fingertip connected to an opposite end of the second link, and having a shape protruding downward with reference to a time, at which the second link is oriented in parallel to the docking direction.

Furthermore, when an imaginary straight line extending in the direction crossing the docking direction, and passing through a portion, at which the driving link and the driving part are connected to each other, is defined as a driving rotation axis, the one end of the driving link may be rotated about the driving rotation axis, and the opposite end of the driving link may be revolved about the driving rotation axis, and when an imaginary straight line extending in parallel to the driving rotation axis and passing through a portion, at which the fixed part and the first link are connected to each other, is defined as a reference rotation axis, the one end of the first link is connected to the fixed part to be rotatable about the reference rotation axis, and the reference rotation axis and the driving rotation axis are spaced apart from each other in the docking direction.

Furthermore, the one end of the driving link may be disposed in the docking direction of the one end of the first link, and the opposite end of the driving link may be disposed between the one end of the second link and the opposite end of the second link.

Furthermore, a spacing distance between the opposite end of the driving link and the one end of the second link may be smaller than a spacing distance between the opposite end of the driving link and the opposite end of the second link.

Furthermore, the movement area may be linearly moved with respect to the fixed part to become more distant from the connection area in the docking direction or become closer to the connection area in the opposite docking direction.

Furthermore, the movable part may have a telescopic structure, an accommodation space that accommodates the movement area may be formed in an interior of the connection area. The charging port opening-closing part may further include a driving part that linearly moves the movement area with respect to the fixed part such that the movement area is inserted into the accommodation space or the movement area is separated from the accommodation space.

### BRIEF DESCRIPTION OF THE DRAWINGS

The above and other objects, features and advantages of the present disclosure should be more apparent from the following detailed description taken in conjunction with the accompanying drawings:

FIG. 1 is a perspective view of an electric vehicle charging apparatus according to a first embodiment of the present disclosure;

FIG. 2 is a side view of an electric vehicle charging apparatus according to the first embodiment of the present disclosure;

FIG. 3 is a view illustrating that a movable part in FIG. 2 rotated in a docking direction and upward;

FIG. 4 is a view illustrating that a fingertip of FIG. 3 approaches a charging cap;

FIG. 5 is a view illustrating the fingertip of FIG. 4 is draped over a charging cap;

FIG. 6 is a view illustrating that the fingertip of FIG. 5 opens a charging port by rotating a charging cap;

FIG. 7 is a view illustrating that an electric vehicle charging apparatus of FIG. 6 is moved to an opposite docking direction;

FIG. 8 is a perspective view of a fingertip according to a first modification of the first embodiment of the present disclosure;

FIG. 9 is a perspective view of a fingertip according to a second modification of the first embodiment of the present disclosure;

FIG. 10 is a perspective view of a fingertip according to a third modification of the first embodiment of the present disclosure;

FIG. 11 is a perspective view of an electric vehicle charging apparatus according to a second embodiment of the present disclosure;

FIG. 12 is a view illustrating that the fingertip of FIG. 11 is moved in a docking direction;

FIG. 13 is a perspective view of an electric vehicle charging apparatus according to a third embodiment of the present disclosure; and

FIG. 14 is a view illustrating that the fingertip of FIG. 13 is moved in a docking direction.

### DETAILED DESCRIPTION

Hereinafter, embodiments of the present disclosure are described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

### First Embodiment

Hereinafter, an electric vehicle charging apparatus 1 according to a first embodiment of the present disclosure will be described.

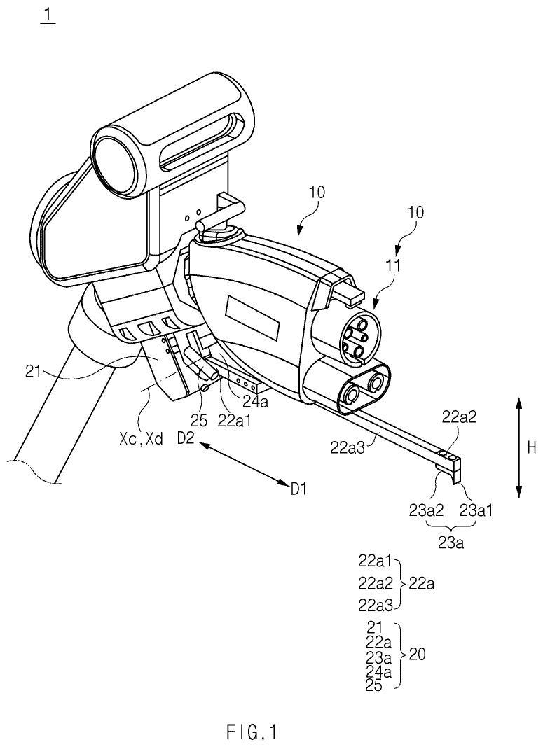

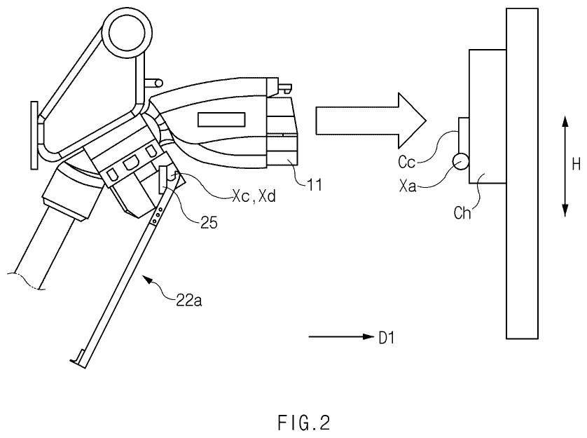

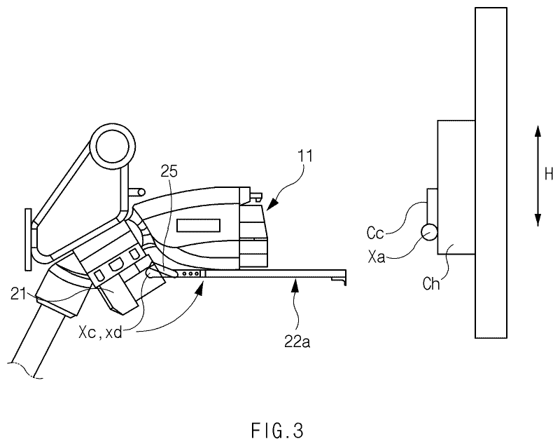

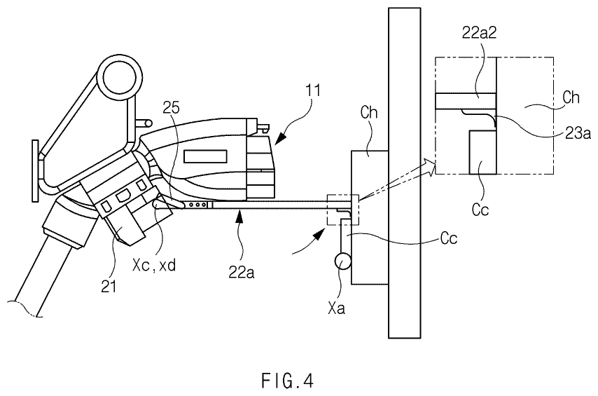

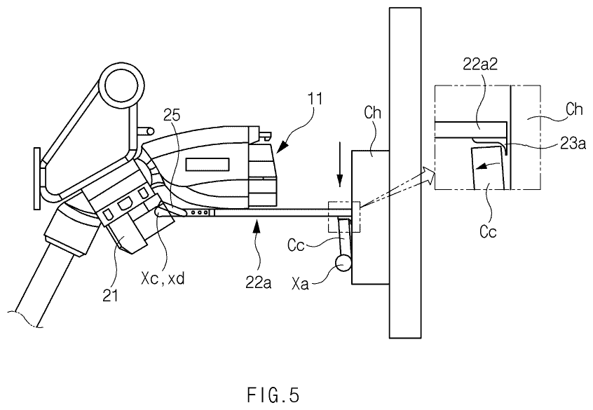

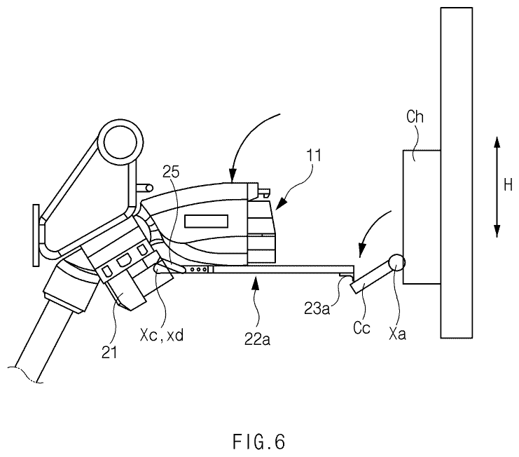

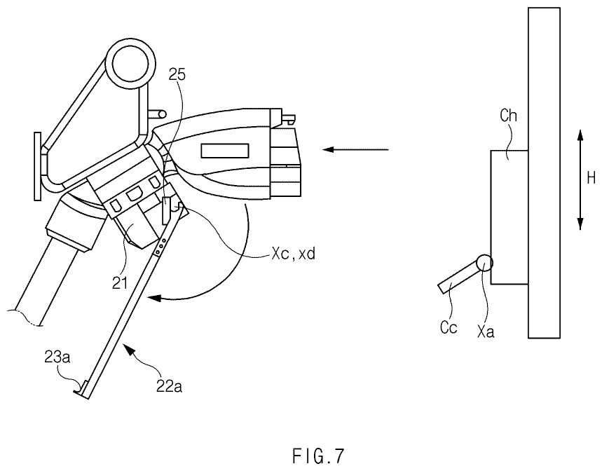

FIG. 1 is a perspective view of an electric vehicle charging apparatus according to a first embodiment of the present disclosure, FIG. 2 is a side view of the electric vehicle charging apparatus according to the first embodiment of the present disclosure, FIG. 3 is a view illustrating that a movable part in FIG. 2 rotated in a docking direction and upward, FIG. 4 is a view illustrating that a fingertip of FIG. 3 approaches a charging cap, FIG. 5 is a view illustrating the fingertip of FIG. 4 is draped over a charging cap, FIG. 6 is a view illustrating that the fingertip of FIG. 5 opens a charging port by rotating the charging cap, and FIG. 7 is a view illustrating that the electric vehicle charging apparatus of FIG. 6 is moved to an opposite docking direction.

Referring to FIGS. 1 to 7, the electric vehicle charging apparatus 1 according to the first embodiment of the present disclosure may supply electric energy to a charging target (e.g., an electric vehicle, a hybrid vehicle, or the like). For example, the electric vehicle charging apparatus 1 may supply electrical energy to the charging target while being electrically coupled with a charging port Ch of the charging target. The electric vehicle charging apparatus 1 may include an electric vehicle charging part 10 and a charging port opening-closing part 20.

The electric vehicle charging part 10 may include a charging body and a docking area 11. The charging body may be provided in an electric vehicle charging station, and may receive electric energy from an energy storage of a charging station or a power grid. The charging body may be named ‘a charging gun’.

The docking area 11 may be configured to be coupled with the charging port Ch of the electric vehicle. The docking area 11 may be disposed in a docking direction D1 of the charging body. The docking direction D1 may be defined as a direction, in which the docking area 11 approaches and connects to the charging port Ch. For example, the docking direction D1 may be defined as a direction, in which the docking area 11 faces the charging port Ch while the docking area 11 and the charging port Ch are disposed to face each other.

The charging port opening-closing part 20 may open or close the charging port Ch. For example, the charging port opening-closing part 20 may rotate a charging cap Cc that is configured to open or close the charging port Ch. The charging cap Cc may be provided on one side of the charging port Ch to be rotatable. For example, the charging cap Cc may be configured to be rotatable about a cap rotation axis Xa between a closed state in which the charging port Ch is closed, and an opened state in which the charging port Ch is opened to the docking area 11 with respect to the docking direction D1. The cap rotation axis Xa may be defined as an imaginary straight line that extends in a direction that extends in a direction (e.g., a direction perpendicular to the docking direction D1) that crosses the docking direction D1. The charging port opening-closing part 20 may include a fixed part 21, a movable part 22a, a fingertip 23a, a driving part 24a, and an elastic member 25.

The fixed part 21 may be fixed to the electric vehicle charging part 10. For example, the fixed part 21 may be mounted on a side of the charging body in an opposite docking direction D2. The opposite docking direction D2 may be defined as an opposite direction to the docking direction D1.

The movable part 22a may be configured to be movable with respect to the fixed part 21. For example, the movable part 22a may be connected to the fixed part 21 to be rotatable about a reference rotation axis Xc. The reference rotation axis Xc may be defined as an imaginary straight line that extends in a direction that crosses the docking direction D1 and an upward/downward direction “H” while passing through an area, in which the movable part 22a and the fixed part 21 are connected to each other.

At least a portion of the movable part 22a may be disposed in a first position that is located in the docking direction D1 of the docking area 11. For example, when the movable part 22a is disposed in the first position, an end (e.g., a movement area 22a2 that is described below) of the movable part 22a in the docking direction D1 is located in the docking direction D1 of the docking area 11. As a more detailed example, when one side of the movable part 22a in the upward/downward direction “H”, which is positioned in the first position, is viewed in parallel to the upward/downward direction “H”, the docking area 11 and the movable part 22a may overlap each other. Furthermore, when the movable part 22a is positioned in the first position, an end of the movable part 22a in the docking direction D1 may protrude in the docking direction D1 with respect to the docking area 11.

Furthermore, the movable part 22a may be positioned in the second position that is located in the opposite docking direction D2 of the docking area 11. This movable part 22a may be configured to be rotated with respect to the fixed part 21 between the first position and the second position. For example, when the movable part 22a is disposed in the second position, all areas of the movable part 22a may be located in the opposite docking direction D2 than an end of the docking area 11 in the docking direction D1. As a more detailed example, when one side of the movable part 22a in an upward/downward direction “H”, which is positioned in the second position, is viewed in parallel to the upward/downward direction “H”, the docking area 11 and the movable part 22a may not overlap each other.

The movable part 22a may be disposed on a lower side of the docking area 11. For example, when one side of the electric vehicle charging apparatus 1 in the docking direction D1 is viewed in parallel to the docking direction D1, the docking area 11 and the movable part 22a may not overlap each other. In other words, when one side of the electric vehicle charging apparatus 1 in the docking direction D1 is viewed in parallel to the docking direction D1, the movable part 22a may be configured to not to block a side of the docking area 11 in the docking direction D1. The movable part 22a may include a connection area 22a1, a movement area 22a2, and a movable body 22a3.

The connection area 22al may be defined as an area of the movable part 22a, which is connected to the fixed part 21 to be rotatable. The connection area 22al may define one end of the movable part 22a. For example, with reference to when the movable part 22a is disposed in the first position, the connection area 22al may define an end in the opposite docking direction D2 of the movable part 22a.

This connection area 22a1 may be connected to the fixed part 21 to be rotatable about the reference rotation axis Xc. The connection area 22a1 may be connected to one end of the movable body 22a3. For example, with reference to when the movable part 22a is disposed in the first position, the connection area 22a1 may be connected to a side of the movable part 22a in the opposite docking direction D2.

The movement area 22a2 may define an opposite end of the movable part 22a. For example, with respect to when the movable part 22a is disposed in the first position, the movement area 22a2 may define an end in the docking area 11 of the movable part.

The movement area 22a2 may be configured to be revolved about the reference rotation axis Xc with respect to the fixed part 21. The movement area 22a2 may be connected to an opposite end of the movable body 22a3. For example, with respect to when the movable part 22a is disposed in the first position, the movement area 22a2 may be connected to a side of the movable body 22a3 in the docking direction D1. As an example, the movement area 22a2 may be formed integrally with the movable body 22a3.

The movable body 22a3 may connect the connection area 22a1 and movement area 22a2. For example, the movable body 22a3 may have a bar shape that extends in one direction between the connection area 22a1 and the movement area 22a2. A length, by which the movable body 22a3 extends in one direction, may be greater than a spacing distance between the connection area 22a1 and the docking area 11 in the docking direction D1.

The fingertip 23a may include a section (a tapered section that is described below) having a shape that protrudes in one direction with respect to the movable part 22a. As illustrated in FIG. 5, the fingertip 23a may be connected to the movement area 22a2. For example, when a direction, in which the connection area 22a1 faces the movement area 22a2, defined as a first direction and a direction that crosses the first direction and in which the tapered section protrudes is defined as a second direction, a fingertip 23a may be connected to a side of the movement area 22a2 in the second direction. For example, the second direction may be a downward direction. The fingertips may include protrusions and finger bodies.

The protrusion may have a shape that protrudes in the second direction with respect to the finger body. At least a portion of the protrusion may include a tapered section. For example, all areas of the protrusion may include a tapered section. The tapered section may have a shape, a width in the first direction of which becomes smaller as it goes in the second direction. The tapered section may be configured to be draped over the charging cap Cc.

The finger body may be connected to a side of the protrusion in an opposite direction (e.g., an upward direction) to the second direction. Furthermore, a side of the finger body in the opposite direction (e.g., the upward direction) to the second direction may be connected to the movement area 22a2. As an example, the finger body and the protrusion may be formed integrally.

Meanwhile, a fingertip 23b according to a first modification of the first embodiment of the present disclosure may be configured differently from the fingertip 23a according to the first embodiment of the present disclosure.

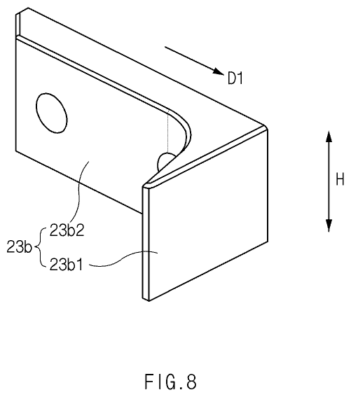

FIG. 8 is a perspective view of a fingertip according to a first modification of the first embodiment of the present disclosure.

Referring to FIG. 8, a tapered section 23b1 of the fingertip 23b according to the first modification of the present disclosure may have a shape that protrudes in a direction (a third direction) that crosses the first direction and the upward/downward direction “H”. For example, the third direction may be defined as any one of a leftward direction and a rightward direction. As a more detailed example, referring to FIG. 8, assuming that the first direction is a forward direction, a tapered section 23b1 may have a shape that protrudes in the leftward or rightward direction. The tapered section 23b1 may be configured to be draped over the left or right side of the charging cap Cc. The tapered section 23b1 may define all areas of the protrusion of the fingertip 23b.

The tapered section 23b1 may have a shape, a width in the first direction of which becomes smaller as it goes in the third direction. For example, assuming that the first direction is the forward direction and the third direction is the rightward direction, the tapered section 23b1 may have a shape, of which a width in the forward-rearward direction becomes smaller as it goes to the right side.

Furthermore, an end of the tapered section 23b1 in the first direction may have a surface shape, of which a normal vector is parallel to the first direction. Furthermore, an end of the tapered section 23b1 in an opposite direction to the first direction may have a shape that is inclined such that and end (e.g., a left end) in the third direction is located in the first direction (e.g., the forward direction) of an end (e.g., a right end) in an opposite direction to the third direction side. As an example, the tapered section 23b1 may have a triangular prism shape having a uniform height in the upward/downward direction “H”.

In one embodiment, a side of the fingertip 23b in an opposite direction to the third direction of the finger body 23b may be connected to a side of the movement area 22a2 in the third direction.

Meanwhile, a fingertip 23c according to the second modification of the first embodiment of the present disclosure may be configured differently from the fingertip 23a according to the first embodiment of the present disclosure and the fingertip 23b according to the first modification.

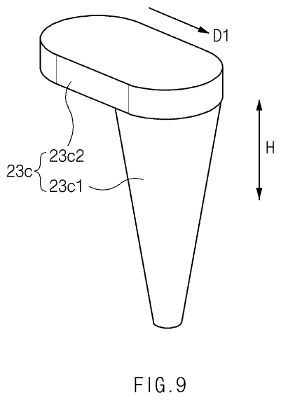

FIG. 9 is a perspective view of a fingertip according to a second modification of the first embodiment of the present disclosure.

Referring to FIG. 9, a tapered section 23c1 of the fingertip 23c according to the second modification of the present disclosure may have a shape that protrudes in the second direction. Furthermore, the tapered section 23c1 may define all areas of the protrusion of the fingertip 23c.

The tapered section 23c1 may have a shape, of which a width in the first direction becomes narrower as it goes downward. For example, the tapered section 23c1 may have a truncated cone shape, of which a width of the upper end in the first direction is greater than a width of the lower end in the first direction.

A side (e.g., an upper side) of the tapered section 23c1 in the opposite direction to the second direction may be connected to a side (e.g., a lower side) of the finger body 23c2 of the fingertip 23c in the second direction. As an example, the finger body 23c2 and the tapered section 23c1 may be formed integrally. The finger body 23c2 may be connected to a lower side of the movement area 22a2.

Meanwhile, a fingertip 23d according to the third modification of the first embodiment of the present disclosure may be configured differently from the fingertip 23a according to the first embodiment of the present disclosure, the fingertip 23b according to the first modification, and the fingertip 23c according to the second modification.

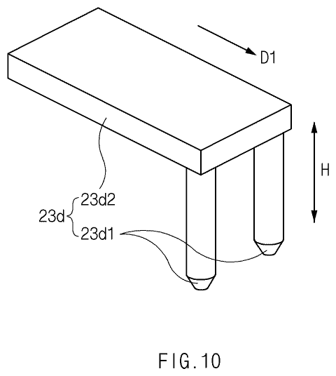

FIG. 10 is a perspective view of a fingertip according to a third modification of the first embodiment of the present disclosure.

Referring to FIG. 10, a tapered section 23d1 of the fingertip 23d according to the third modification of the present disclosure may define an end of the protrusion of the fingertip 23d in the second direction (e.g., a downward direction). A plurality of protrusions may be provided in the fingertip 23d. The plurality of protrusions may be configured to be spaced apart from each other in the third direction (e.g., the leftward/rightward direction).

The tapered section 23d1 may have a shape, of which a width in the first direction becomes narrower as it goes in the second direction (e.g., a downward direction). For example, the tapered section 23d1 may have a truncated cone shape, of which a width of the upper end in the first direction is greater than a width of the lower end in the first direction.

Referring again to FIGS. 1 and 2, the driving part 24a may provide rotational power to the movable part 22a. For example, the driving part 24a may rotate the movable part 22a about the driving rotation axis Xd. As an example, the driving part 24a may be a motor including a stator, a rotor, a shaft, and a housing. As an example, the driving rotation axis Xd may be defined as an imaginary straight line that is parallel to the reference rotation axis Xc. As a detailed example, the reference rotation axis Xc and the driving rotation axis Xd may be defined as the same imaginary straight line.

The driving part 24a may be supported by the fixed part 21. For example, the driving part 24a may be supported by the fixed part 21 so that a relative position thereof with respect to the fixed part 21 is fixed.

The elastic member 25 may be configured such that one end thereof is connected to the fixed part 21 and an opposite end thereof is connected to the movable body 22a3. As an example, the elastic member 25 may be provided as a tensile coil spring. The elastic member 25 may be extended or contracted so that a distance between opposite ends of the elastic member 25 increases or decreases.

Referring to FIG. 3, when the movable part 22a is positioned in the first position (when the movable body 22a3 is oriented in parallel to the docking direction D1), the elastic member 25 may be oriented in a direction that crosses the docking direction D1. For example, when the movable part 22a is positioned in the first position, the opposite end of the elastic member 25 may be oriented such that the opposite end of the elastic member 25 is located on a lower side or in the docking direction D1 of the one end of the elastic member 25. One end of the elastic member 25 may be located on an upper side of the reference rotation axis Xc (or the driving rotation axis Xd).

Hereinafter, a process of opening the charging cap Cc by using the charging port opening-closing part 20 is described with reference to FIGS. 2 to 7.

Referring to FIG. 2, while the movable part 22a is positioned in the second position, the docking area 11 may perform an operation of approaching the charging port Ch in the docking direction D1.

Referring to FIG. 3, after the above-described approach operation is performed, the driving part 24a may perform a movable part rotation operation, i.e., an operation of rotating the movable part 22a in the docking direction D1 and upward so that the movable part 22a is changed from the second position to the first position.

Referring to FIG. 4, after the above-described movable part rotation operation is performed, a fingertip adhesion operation of moving the electric vehicle charging apparatus 1 in the docking direction D1 may be performed so that a lower end of the tapered section of the fingertip 23a is adhered to an upper end of the charging cap Cc.

Referring to FIG. 5, after the fingertip adhesion operation is performed, a fingertip insertion operation, i.e., an operation of moving the electric vehicle charging apparatus 1 downward, may be performed so that the tapered section of the fingertip 23a is inserted between the charging cap Cc and the charging port Ch. When the fingertip insertion operation is performed, the charging cap Cc may be rotated about the cap rotation axis Xa with respect to the charging port Ch. The cap rotation axis Xa may be defined as an imaginary straight line that extends to be perpendicular to the upward-downward direction “H” and the docking direction D1 and passes through the lower end of the charging cap Cc.

Referring to FIG. 6, after the fingertip insertion operation is performed, a charging port opening operation, i.e., an operation of moving the electric vehicle charging apparatus 1 in the opposite docking direction D2 and downward, may be performed so that the charging port Ch opens in the opposite docking direction D2. For example, when the charging port opening operation is performed, the charging cap Cc may be rotated in the opposite docking direction D2 and downward about the cap rotation axis Xa.

Referring to FIG. 7, after the charging port opening operation is performed, a docking preparation operation, i.e., an operation for the driving part 24a to rotate the movable part 22a, may be performed so that the electric vehicle charging apparatus 1 is moved in the opposite docking direction D2 and the movable part 22a is switched from the first position to the second position.

After the docking preparation operation is performed, a docking operation of moving the electric vehicle charging apparatus 1 may be performed so that the docking area 11 is coupled with the charging port Ch.

The approach operations, the movable part rotation operations, the fingertip insertion operation, the charging port opening operation, the docking preparation operation, and the docking operations may be controlled by a charging robot. The charging robot may be electrically connected to the electric vehicle charging apparatus 1, and may be implemented by a process having a function of decoding and executing commands based on input information.

### Second Embodiment

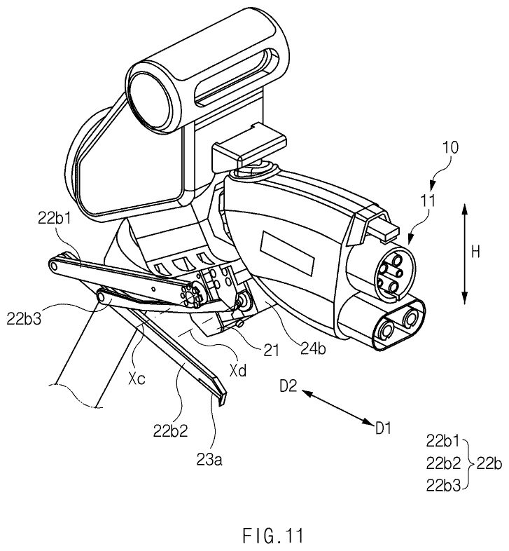

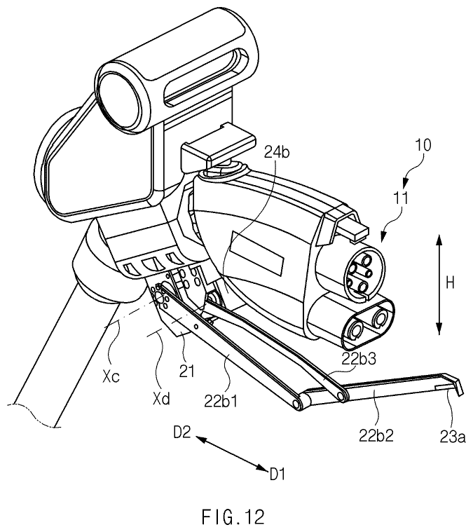

Hereinafter, the electric vehicle charging apparatus according to the second embodiment of the present disclosure is described with reference to FIGS. 11 and 12. In a description of the electric vehicle charging apparatus according to the second embodiment of the present disclosure, the differences from the first embodiment of the present disclosure are mainly described.

FIG. 11 is a perspective view of the electric vehicle charging apparatus according to the second embodiment of the present disclosure, and FIG. 12 is a view illustrating that the fingertip of FIG. 11 is moved in the docking direction.

The electric vehicle charging apparatus according to the second embodiment of the present disclosure may include an electric vehicle charging part 10 and a charging port opening-closing part 20. The description of the electric vehicle charging part 10 and the charging port opening-closing part 20 according to the second embodiment is replaced with the description of the electric vehicle charging part 10 and the charging port opening-closing part 20 according to the first embodiment.

The charging port opening-closing part 20 according to the second embodiment may include a fixed part 21, a movable part 22b, a fingertip 23a, and a driving part 24b. A description of the fixed part 21 and the fingertip 23a according to the second embodiment is replaced with the description of the fixed part 21 and the fingertip 23a according to the first embodiment.

The movable part 22b according to the second embodiment may have a structure including a plurality of links. The movable part 22b may include a first link 22b1, a second link 22b2, and a driving link 22b3.

One end of the first link 22b1 may be connected to the fixed part 21 to be rotatable. For example, one end of the first link 22b1 may be connected to the fixed part 21 to be rotatable about the reference rotation axis Xc. Furthermore, the opposite end of the first link 22b1 may be configured to be revolved about the reference rotation axis Xc.

One end of the second link 22b2 may be connected to an opposite end of the first link 22b1 to be rotatable. The fingertip 23a may be connected to an opposite end of the second link 22b2.

One end of the driving link 22b3 may be connected to the driving part 24b. The one end of the driving link 22b3 may be configured to be rotated about the driving rotation axis Xd. The one end of the driving link 22b3 may be disposed in the docking direction D1 (or the opposite docking direction D2) of the one end of the first link 22b1. For example, the driving rotation axis Xd may be located in the docking direction D1 (or the opposite docking direction D2) of the reference rotation axis Xc. In other words, the driving rotation axis Xd and the reference rotation axis Xc may be spaced apart from each other in the docking direction D1.

The opposite end of the driving link 22b3 may be connected to the second link 22b2 to be rotatable. For example, the opposite end of the driving link 22b3 may be disposed between the one end of the second link 22b2 and the opposite end of the second link 22b2. In other words, the opposite end of the driving link 22b3 may be connected to an area of the second link 22b2, which is spaced apart from the opposite ends of the second link 22b2. The opposite end of the driving link 22b3 may be configured to be revolved about the driving rotation axis Xd.

For example, the opposite end of the driving link 22b3 may be located closer to the one end of the second link 22b2 than the opposite end of the second link 22b2. As a detailed example, a first distance, which is a spacing distance between the opposite end of the driving link 22b3 and one end of the second link 22b2, may be smaller than a spacing distance between the opposite end of the driving link 22b3 and the opposite end of the second link 22b2.

### Third Embodiment

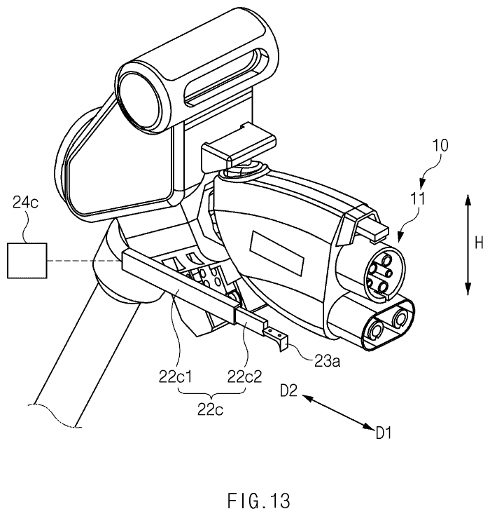

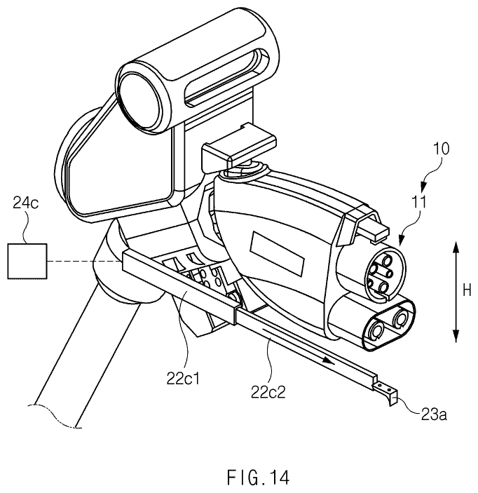

Hereinafter, the electric vehicle charging apparatus according to the third embodiment of the present disclosure is described with reference to FIGS. 13 and 14. In a description of the electric vehicle charging apparatus according to the third embodiment of the present disclosure, the differences from the first embodiment and the second embodiment of the present disclosure are mainly described.

FIG. 13 is a perspective view of the electric vehicle charging apparatus according to the third embodiment of the present disclosure, and FIG. 14 is a view illustrating that the fingertip of FIG. 13 is moved in the docking direction.

The electric vehicle charging apparatus according to the third embodiment of the present disclosure may include an electric vehicle charging part 10 and a charging port opening-closing part 20. The description of the electric vehicle charging part 10 and the charging port opening-closing part 20 according to the third embodiment is replaced with the description of the electric vehicle charging part 10 and the charging port opening-closing part 20 according to the first embodiment.

The charging port opening-closing part 20 according to the third embodiment may include a fixed part 21, a movable part 22c, a fingertip 23a, and a driving part 24d. A description of the fixed part 21 and the fingertip 23a according to the third embodiment is replaced with the description of the fixed part 21 and the fingertip 23a according to the first embodiment.

The movable part 22c according to the third embodiment may have a telescopic structure, of which a size of a spacing distance between opposite ends may be adjusted. The movable part 22c may include a connection area 22c1 and a movement area 22c2.

The connection area 22c1 may be connected to the fixed part 21 so that a relative position thereof with respect to the fixed part 21 is fixed. An accommodation space may be formed in an interior of the connection area 22c1 to accommodate the movement area 22c2. For example, the accommodation space may have a shape that is recessed in the opposite docking direction D2.

The movement area 22c2 may be configured to be linearly moved with respect to the fixed part 21 to become more distant from the connection area 22c1 in the docking direction D1 or move closer to the connection area 22c1 in the opposite docking direction D2. In other words, the movement area 22c2 is designed to move linearly relative to the fixed part 21, either increasing its distance from the connection area 22c1 in the docking direction D1 or decreasing its distance in the opposite direction D2. For example, when the movement area 22c2 becomes more distant from the connection area 22c1 in the docking direction D1, the movement area 22c2 may deviate from the accommodation space in the opposite docking direction D2. As a detailed example, when the movement area 22c2 become more distant from the connection area 22c1 in the docking direction D1, an end of the movement area 22c2 in the opposite docking direction D2 may become more distant from an end of the accommodation space in the opposite docking direction D2. In other words, when the movement area 22c2 becomes more distant from the connection area 22c1 in the docking direction D1, an area of the movement area 22c2, which is inserted into the accommodation space, may decrease.

Furthermore, when the movement area 22c2 moves closer to the connection area in the opposite docking direction D2, the movement area 22c2 may be inserted into the accommodation space. For example, when the movement area 22c2 becomes closer to the connection area in the opposite docking direction D2, the end of the movement area 22c2 in opposite docking direction D2 may become closer to the end of the accommodation space in opposite docking direction D2. In other words, when the movement area 22c2 moves closer to the connection area in the opposite docking direction D2, an area of the movement area 22c2, which is inserted into the accommodation space, may increase.

A fingertip 23a may be connected to the end of the movement area 22c2 in the docking direction D1. The movement area 22c2 may include a plurality of unit movable members. When, among a plurality of unit movable members, two movable members that are adjacent to each other are defined as a first movable member and a second movable member, respectively, the relationship between the first movable member and the second movable member may correspond to the relationship between the connection area 22c1 and the movement area 22c2.

For example, when it is assumed that, among the first member and the second member, a movable member that is located in the relatively opposite docking direction D2 is the first movable member, a first accommodation space that may accommodate the second movable member may be formed in the first movable member. Furthermore, the second movable part may be configured to be linearly moved with respect to the first movable member so that an end of the second movable member in the opposite docking direction D2 becomes more distant from or closer to an end of the first accommodation space in the opposite docking direction D2. Meanwhile, the plurality of unit movable members may include not only the first movable member and the second movable member, but also three or more movable members, and a description of two adjacent ones of the plurality of unit movable members is replaced with the description of the first movable member and the second movable member. The driving part 24c may be an actuator for linearly moving the movement area 22c2 with respect to the connection area 22c1.

The electric vehicle charging apparatus according to an embodiment of the present disclosure automate and eliminates manual intervention in a process of charging electric vehicles.

In the above description, just because all the components constituting the embodiment of the present disclosure are described as being combined or operating in combination, the present disclosure is not necessarily limited to this embodiment. In other words, within the scope of the purpose of the present disclosure, all of the components may operate in selective combination of one or more. In addition, terms such as “include,” “comprise,” or “have” described above mean that the corresponding component may be present, and thus do not exclude other components unless specifically stated to the contrary, and rather, it should be interpreted as being able to include other components. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. An electric vehicle charging apparatus comprising:
an electric vehicle charging part including a docking area configured to couple with a charging port of an electric vehicle; and
a charging port opening-closing part configured to be mounted on the electric vehicle charging part,
wherein the charging port opening-closing part includes:
a fixed part fixed to the electric vehicle charging part; and
a movable part configured to be movably connected to the fixed part, and
wherein the movable part is configured to be movable with respect to the fixed part between a first position, in which an end of the movable part in a docking direction is located in a docking direction of the docking area, and a second position located in an opposite docking direction that is an opposite direction to the docking direction of the docking area.

2. The electric vehicle charging apparatus of claim 1, wherein the docking direction crosses an upward-downward direction, and
wherein the movable part is disposed on a lower side of the docking area.

3. The electric vehicle charging apparatus of claim 2, wherein the movable part includes:
a connection area defining one end of the movable part, and connected to the fixed part; and
a movement area defining an opposite end of the movable part, and configured to be movable with respect to the connection area, and
wherein the charging port opening-closing part further includes:
a fingertip connected to the movement area, and including a section having a shape protruding with respect to the movement area in a direction crossing the docking direction with reference to a time, at which the movable part is oriented in parallel to the docking direction.

4. The electric vehicle charging apparatus of claim 3, wherein the connection area is connected to the fixed part to be rotatable about a reference rotation axis, and
the movement area is configured to be revolved about the reference rotation axis, wherein the reference rotation axis is an imaginary straight line extending in the direction crossing the docking direction, and passing through a portion, at which the connection area and the fixed part are connected to each other.

5. The electric vehicle charging apparatus of claim 3, wherein the movable part includes:
a movable body extending between the connection area and the movement area, and connecting the connection area and the movement area, and
wherein the charging port opening-closing part further includes:
an elastic member including: one end connected to the fixed part, and an opposite end connected to the movable body to be prolonged or contracted.

6. The electric vehicle charging apparatus of claim 5, wherein the elastic member is provided as a tensile coil spring, and is oriented in the direction crossing the docking direction when the movable body is oriented in parallel to the docking direction.

7. The electric vehicle charging apparatus of claim 6, wherein the elastic member is oriented such that the opposite end of the elastic member is located on a lower side of and in the docking direction of the one end of the elastic member when the movable body is oriented in parallel to the docking direction.

8. The electric vehicle charging apparatus of claim 3, wherein
the shape of the section of the fingertip has a width in a first direction, and the width becomes smaller as advancing in a second direction,
wherein the first direction is a direction, in which the connection area faces the movement area, and the second direction is a direction crossing the first direction, and the section of the fingertip protrudes in the second direction.

9. The electric vehicle charging apparatus of claim 1, wherein the charging port opening-closing part further includes:
a driving part configured to rotate the movable part with respect to the fixed part,
wherein the movable part includes:
a first link having one end connected to the fixed part and configured to be rotatable;
a second link having one end connected to an opposite end of the first link and configured to be rotatable; and
a driving link configured to be rotatable and including: one end connected to the driving part, and an opposite end connected to the second link, and
wherein the charging port opening-closing part further includes:
a fingertip connected to an opposite end of the second link, and having a shape protruding downward with reference to a time, at which the second link is oriented in parallel to the docking direction.

10. The electric vehicle charging apparatus of claim 9, wherein when an imaginary straight line extending in a direction crossing the docking direction, and passing through a portion, at which the driving link and the driving part are connected to each other, is defined as a driving rotation axis,
the one end of the driving link is configured to be rotated about the driving rotation axis, and the opposite end of the driving link is configured to be revolved about the driving rotation axis, and
wherein when an imaginary straight line extending in parallel to the driving rotation axis and passing through a portion, at which the fixed part and the first link are connected to each other, is defined as a reference rotation axis,
the one end of the first link is connected to the fixed part to be rotatable about the reference rotation axis, and the reference rotation axis and the driving rotation axis are spaced apart from each other in the docking direction.

11. The electric vehicle charging apparatus of claim 9, wherein the one end of the driving link is disposed in the docking direction of the one end of the first link, and
wherein the opposite end of the driving link is disposed between the one end of the second link and the opposite end of the second link.

12. The electric vehicle charging apparatus of claim 11, wherein a spacing distance between the opposite end of the driving link and the one end of the second link is smaller than a spacing distance between the opposite end of the driving link and the opposite end of the second link.

13. The electric vehicle charging apparatus of claim 3, wherein the movement area is configured to be linearly moved relative to the fixed part to become more distant from the connection area in the docking direction or become closer to the connection area in the opposite docking direction.

14. The electric vehicle charging apparatus of claim 13, wherein the movable part has a telescopic structure,
wherein an accommodation space configured to accommodate the movement area is formed in an interior of the connection area, and
wherein the charging port opening-closing part further includes:
a driving part configured to linearly move the movement area relative to the fixed part such that the movement area is inserted into the accommodation space or the movement area is separated from the accommodation space.
